(19) United States
(12) Patent Application Publication
(10) Pub. No.: US 2018/0075317 A1
(43) Pub. Date: Mar. 15, 2018

(54) PERSON CENTRIC TRAIT SPECIFIC PHOTO MATCH RANKING ENGINE

(71) Applicant: Microsoft Technology Licensing, LLC, Redmond, WA (US)

(72) Inventors: Federico E. GOMEZ SUAREZ, Sammamish, WA (US); Cristian CANTON FERRER, Sammamish, WA (US)

(21) Appl. No.: 15/260,506

(22) Filed: Sep. 9, 2016

(51) Int. Cl. G06K 9/46; G06K 9/62; G06F 17/30

(52) U.S. Cl. CPC G06K 9/4671; G06T 1/0007; G06F 17/30256; G06K 9/6262

(57) ABSTRACT

In a face recognition system, a face classifier is configured to receive an input image, and analyze the input image to determine at least one specific trait. A feature extractor is configured to receive a plurality of data sets based on the determined specific trait, and generate a plurality of feature sets corresponding to the plurality of data sets, wherein respective ones of the feature sets include corresponding features extracted from respective ones of the data sets. A feature comparator is configured to receive a plurality of images from an image database, compare the input image against the plurality of images from the image database by using the plurality of feature sets generated by the feature extractor, and output a ranking of potential matches indicating a likelihood of a match between the input image and the plurality of images in the image database.

### FIELD OF THE DISCLOSURE

The present disclosure relates generally to image recognition, and more particularly, to techniques for face recognition using specific traits.

### BACKGROUND

Image recognition techniques oftentimes are used to locate, identify, and/or verify one or more subjects appearing in an image. Some image recognition techniques involve extracting a set of landmarks or features from an image, and comparing the extracted set of features with corresponding features extracted from one or multiple other images in order to identify or verify the image. For instance, in facial recognition, one or more traits may be extracted from an image of a face, such as position, size, and/or shape of the eyes, nose, cheekbones, etc. in the face, and these extracted traits may be compared with corresponding traits extracted from one or more other images to verify or to identify the face.

Person identification in unconstrained environments has been commonly addressed using generic machine learning based face verification systems that account globally for facial traits. However, to increase the accuracy of the facial recognition, the number of images stored in the database to compare the image to needs to be sufficiently large. Such techniques, however, result in a less accurate representation of the subject in the image, and leads to less accurate or incorrect identification and/or verification of the subject in the image.

### SUMMARY

According to an embodiment, an image processing system comprises a face classifier configured to receive an input image, and analyze the input image to determine at least one specific trait. A feature extractor is configured to receive a plurality of data sets based on the determined specific trait, wherein respective ones of the data sets include pairs of images with each pair including one image that includes the specific trait and another image that does not include the specific trait, and generate a plurality of feature sets corresponding to the plurality of data sets, wherein respective ones of the feature sets include corresponding features extracted from respective ones of the data sets. A feature comparator is configured to receive a plurality of images from an image database, compare the input image against the plurality of images from the image database by using the plurality of feature sets generated by the feature extractor, and output a ranking of potential matches indicating a likelihood of a match between the input image and the plurality of images in the image database.

In another embodiment, a tangible, non-transitory computer readable medium, or media, storing machine readable instructions that, when executed by one or more processors, cause the one or more processors to receive an input image, analyze the input image to determine at least one specific trait, receive a plurality of data sets based on the determined specific trait, wherein respective ones of the data sets include pairs of images with each pair including one image that includes the specific trait and another image that does not include the specific trait, generate a plurality of feature sets corresponding to the plurality of data sets, wherein respective ones of the feature sets include corresponding features extracted from respective ones of the data sets, receive a plurality of images from an image database, compare the input image against the plurality of images from the image database by using the plurality of feature sets, and output a ranking of potential matches indicating a likelihood of a match between the input image and the plurality of images in the image database.

In still another embodiment, a method for processing images includes receiving an input image, analyzing the input image to determine at least one specific trait, receiving a plurality of data sets based on the determined specific trait, wherein respective ones of the data sets include pairs of images with each pair including one image that includes the specific trait and another image that does not include the specific trait, generating a plurality of feature sets corresponding to the plurality of data sets, wherein respective ones of the feature sets include corresponding features extracted from respective ones of the data sets, receiving a plurality of images from an image database, comparing the input image against the plurality of images from the image database by using the plurality of feature sets, and outputting a ranking of potential matches indicating a likelihood of a match between the input image and the plurality of images in the image database.

### BRIEF DESCRIPTION OF THE DRAWINGS

While the appended claims set forth the features of the present techniques with particularity, these techniques may be best understood from the following detailed description taken in conjunction with the accompanying drawings of which:

FIG. 1 is a block diagram of an example face recognition system, according to an embodiment.

FIG. 2 is a flow diagram illustrating an example method for processing images in the face recognition system of FIG. 1, according to an embodiment.

FIG. 3 is a flow diagram illustrating an example method for facial recognition in the face recognition system of FIG. 1, according to another embodiment.

FIG. 4 is a block diagram of a computer system suitable for implementing one or more components of the face recognition system of FIG. 1, according to an embodiment.

### DETAILED DESCRIPTION

The following discussion is directed to various exemplary embodiments. However, one possessing ordinary skill in the art will understand that the examples disclosed herein have broad application, and that the discussion of any embodiment is meant only to be an example of that embodiment, and not intended to suggest that the scope of the disclosure, including claims is limited to that embodiment.

Certain terms are used throughout the following description to refer to particular features or components. As one skilled in the art will appreciate, different persons may refer to the same feature or component by different names. The drawing figures are not necessarily to scale. Certain features and components herein may be shown exaggerated in scale or somewhat schematic form and some details of the conventional elements may not be shown in interest of clarity and conciseness.

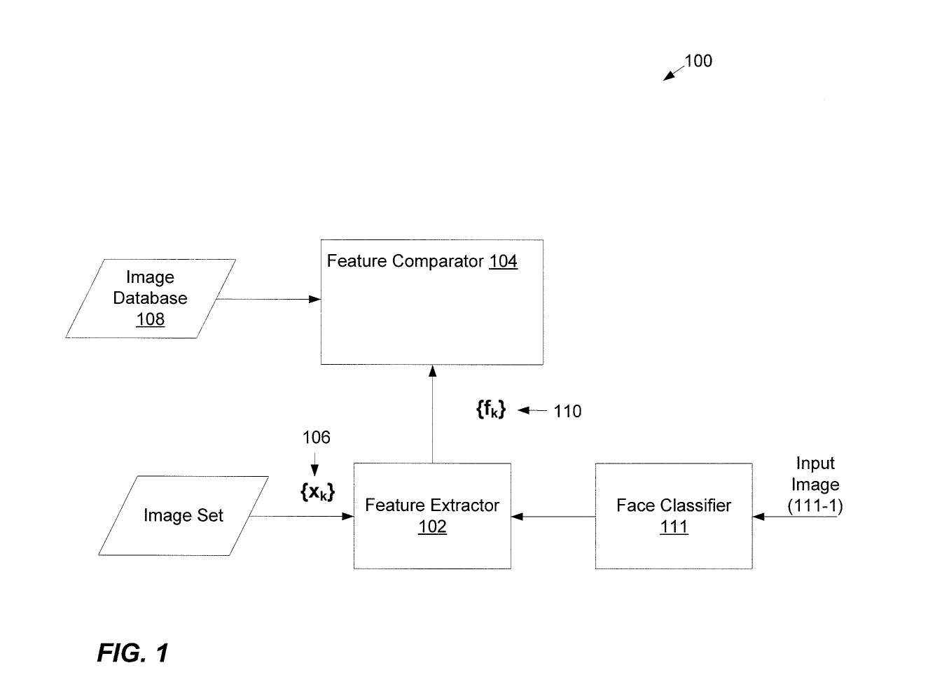

In various embodiments described below, a face recognition system may generate identification and/or verification decisions for various images based on a comparison of specific traits included in the image. FIG. 1 is a block diagram of an example face recognition system 100, according to an embodiment. The face recognition system 100 includes a feature extractor 102 and a feature comparator 104. The feature extractor 102 receives a plurality of data sets {xₖ} 106 corresponding to a plurality of images, and generates, based on respective ones of the data sets {xₖ} 106, respective feature sets {fₖ} 110 that include corresponding features extracted from different ones of the data sets {xₖ} 106. Each feature set {fₖ} 110 may be a data structure, such as a vector, that includes a plurality of elements indicating respective features extracted from respective data sets {xₖ}. For example, respective ones of the feature sets {fₖ} 110 may include indications of facial features, such as position, size and/or shape of the eyes, nose, cheekbones, etc. extracted from respective images. The feature extractor 102 may operate on the data sets {xₖ} 106 to embed each data set x to a respective feature set f that includes a set of features generated based on the data set x. In an embodiment, the feature extractor 102 implements a neural network, such as a deep convolutional neural network (CNN) or another suitable type of neural network to embed a data set x to a corresponding feature set f. In another embodiment, the feature extractor 102 implements a suitable neural network other than a CNN to embed respective data sets x to corresponding feature sets f, or implements a suitable feature extraction system other than a neural network to embed respective data sets x to corresponding feature sets f.

With continued reference to FIG. 1, the feature extractor 102 receives an input image via a face classifier 111. According to an embodiment, the face classifier 111 is configured to analyze a face to be verified and determine the predominant trait. According to yet another embodiment, the face classifier 11 combines one or more specific traits in a case where the face includes more than one dominant trait. The feature extractor 102 of the face recognition system 100 collects a dataset of face pairs that are to be verified—i.e., two faces belonging to the same person. According to an embodiment, the dataset may be constructed with pairs of positive/negative examples of faces exhibiting the specific predominant trait (for instance, age range, scars, tattoos, moles, race, gender, etc.). The face recognition system, using the feature sets {fₖ} 110 constructs a Siamese architecture, where for each of the two images to be compared; the N-dimensional feature vector {fₖ} 110 is computed. The feature sets {fₖ} 110 may be provided to the feature aggregator 104. The feature comparator 104 determines a cost function quantifying the similarly of the two features. After training the face recognition system 100 in this manner, the face recognition system 100 is able to exploit a specific trait that yields to an output value describing the likelihood of two faces being from the same person.

The face recognition system 100 can therefore be trained for each specific trait by inputting a dataset of face pairs having the specific trait. The feature comparator 104 compares the input image against an image database 108 to determine the potential matches. More particularly, the feature comparator 104 generates a cost function quantifying the similarly of the input image against the images in the image database 108. According to an embodiment, the images in the plurality of data sets may be collected from law enforcement services. According to another embodiment, the images in the plurality of data sets 108 may be collected from social networking sites. A person skilled in the art will appreciate that any number of sources may be used to obtain the plurality of data sets.

According to an embodiment, the face recognition system 100 outputs a ranking of potential matches that are similar to the input image. The face recognition system 100 can therefore provide results with significantly higher accuracy while requiring a smaller dataset than would otherwise be needed if the system were not trained for the specific trait. Moreover, the reduced dataset requirement increases computational efficiency and reduces storage requirements.

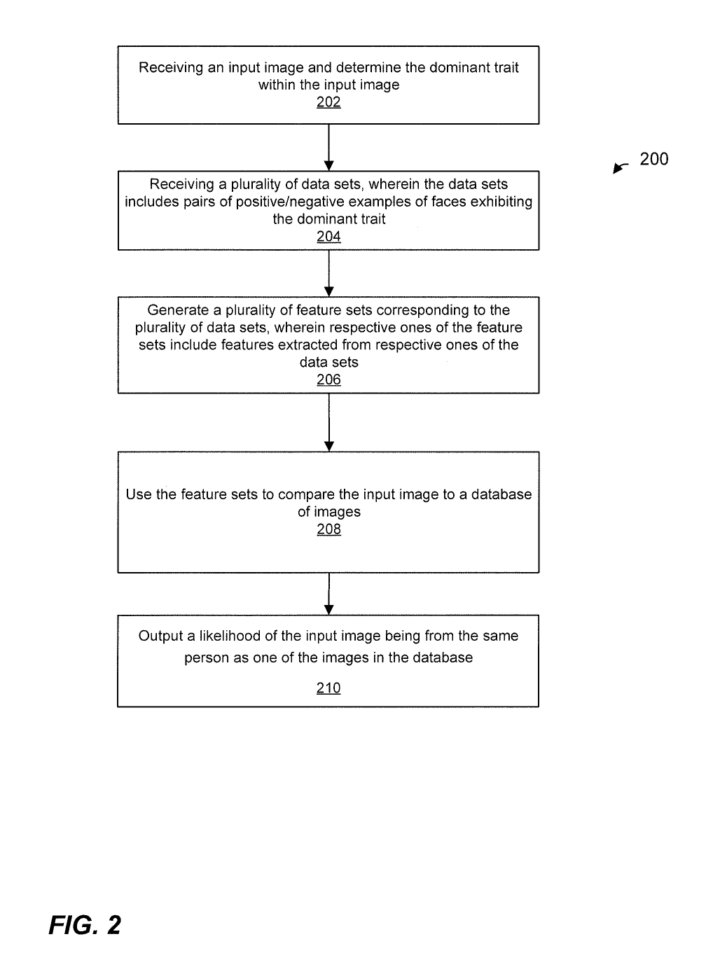

FIG. 2 is a flow diagram of a method 200 for facial recognition in a face recognition system, according to an embodiment. In an embodiment, the method 200 is implemented by the face recognition system 100 of FIG. 1. In an embodiment, the method 200 is implemented by face recognition systems different from the face recognition system 100 of FIG. 1.

At block 202, an image may be received. The image may be analyzed to determine one or more specific traits present in the image. For instance, the specific trait may be one or more of age range, gender, race, skin color, tattoos, or scars. A person skilled in the art will understand that any number of specific traits may be identified. At block 204, a plurality of data sets may be received. Respective ones of the data sets at block 204 may include pairs of faces of same person where one of the pair includes the specific trait and the other of the pair does not include the specific trait.

At block 206, a plurality of feature sets may be generated based on the plurality of data sets received at block 204. Respective ones of the feature sets generated at block 206 may include features extracted from the respective data sets. Each feature set may be a data structure, such as a vector, that includes a plurality of elements indicating respective features extracted from respective data sets.

At block 208, the feature vector may be used to compare the input image against the plurality of data sets. More particularly, a feature vector may be computed for the input image against a database of images to determine potential matches. At block 210, a ranking of potential matches indicating the likelihood that the input image matches one of the images in the image database may be output.

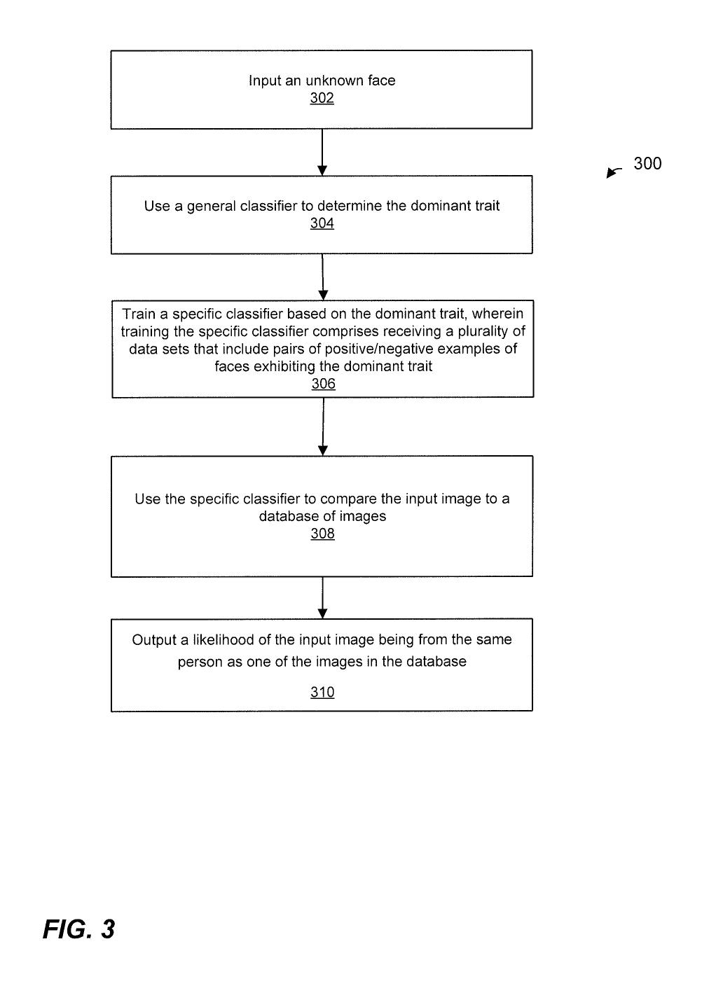

FIG. 3 is a flow diagram of a method 300 for facial recognition in a face recognition system, according to an embodiment. In an embodiment, the method 300 is implemented by the face recognition system 100 of FIG. 1. In an embodiment, the method 300 is implemented by face recognition systems different from the face recognition system 100 of FIG. 1.

At block 302, an unknown face may be received. At block 304, a general classifier may analyze the unknown face to determine one or more dominant traits present in the face. For instance, the dominant trait may be one or more of age range, gender, race, skin color, tattoos, or scars. A person skilled in the art will understand that any number of dominant traits may be identified. The general classifier may include a large corpus of faces and compare the unknown face against this dataset to determine the dominant trait.

At block 306, a plurality of data sets may be received. Respective ones of the data sets at block 306 may include pairs of faces of same person where one of the pair includes the dominant trait and the other of the pair does not include the dominant trait. Moreover, at block 306, a specific classifier may be trained based on the plurality of received data sets.

At block 308, the trained specific classifier is used to compare the input image against an image database to determine potential matches. At block 310, a ranking of potential matches indicating the likelihood that the input image matches one of the images in the image database may be output.

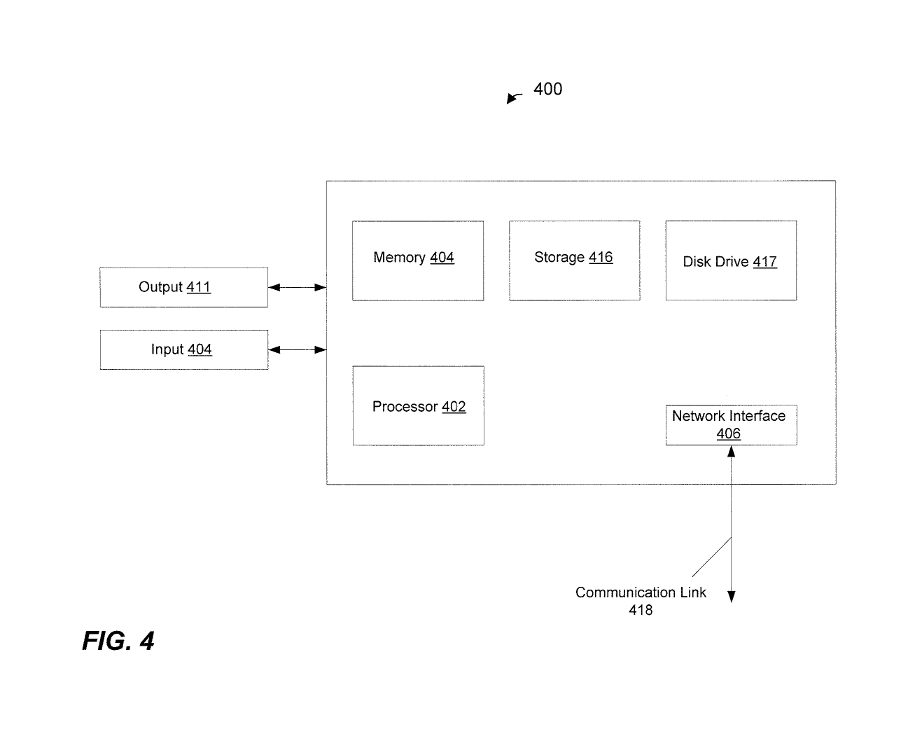

FIG. 4 is a block diagram of a computing system 400 suitable for implementing one or more embodiments of the present disclosure. In its most basic configuration, the computing system 400 may include at least one processor 402 and at least one memory 404. The computing device 400 may also a bus (not shown) or other communication mechanism for communicating information data, signals, and information between various components of computer system 400. Components may include an input component 404 that processes a user action, such as selecting keys from a keypad/keyboard, selecting one or more buttons or links, etc., and sends a corresponding signal to the at least one processor 402. Components may also include an output component, such as a display 411 that may display, for example, results of operations performed by the at least one processor 402. A transceiver or network interface 406 may transmit and receive signals between computer system 400 and other devices, such as user devices that may utilize results of processes implemented by the computer system 400. In one embodiment, the transmission is wireless, although other transmission mediums and methods may also be suitable.

The at least one processor 402, which can be a micro-controller, digital signal processor (DSP), or other processing component, processes these various signals, such as for display on computer system 400 or transmission to other devices via a communication link 418. The at least one processor 402 may also control transmission of information, such as cookies or IP addresses, to other devices. The at least one processor 402 may execute computer readable instructions stored in the memory 404. The computer readable instructions, when executed by the at least one processor 402, may cause the at least one processor 402 to implement processes associated with image processing and/or recognition of a subject based on a plurality of images.

Components of computer system 400 may also include at least one static storage component 416 (e.g., ROM) and/or at least one disk drive 417. Computer system 400 may perform specific operations by processor 412 and other components by executing one or more sequences of instructions contained in system memory component 414. Logic may be encoded in a computer readable medium, which may refer to any medium that participates in providing instructions to the at least one processor 402 for execution. Such a medium may take many forms, including but not limited to, non-transitory media, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

While various operations of a face recognition system have been described herein in terms of “modules” or “components,” it is noted that that terms are not limited to single units or functions. Moreover, functionality attributed to some of the modules or components described herein may be combined and attributed to fewer modules or components. Further still, while the present invention has been described with reference to specific examples, those examples are intended to be illustrative only, and are not intended to limit the invention. It will be apparent to those of ordinary skill in the art that changes, additions or deletions may be made to the disclosed embodiments without departing from the spirit and scope of the invention. For example, one or more portions of methods described above may be performed in a different order (or concurrently) and still achieve desirable results.

What is claimed is:

1. A face recognition system comprising:
a face classifier configured to
receive an input image, and
analyze the input image to determine at least one specific trait;
a feature extractor configured to
receive a plurality of data sets based on the determined specific trait, and
generate a plurality of feature sets corresponding to the plurality of data sets, wherein respective ones of the feature sets include corresponding features extracted from respective ones of the data sets; and
a feature comparator configured to
receive a plurality of images from an image database,
compare the input image against the plurality of images from the image database by using the plurality of feature sets generated by the feature extractor, and
selects potential matches between the input image and the plurality of images in the image database.

2. The face recognition system of claim 1, wherein respective ones of the data sets include pairs of images with each pair including one image that includes the specific trait and another image that does not include the specific trait.

3. The face recognition system of claim 1, wherein the specific trait is one or more of age range, race, skin color, gender, a scar, or a tattoo.

4. The face recognition system of claim 1, wherein the feature extractor is configured to generate a plurality of vectors that includes a plurality of elements indicating respective features extracted from respective data sets.

5. The face recognition system of claim 1, wherein the face classifier is configured to compare the received image against a database of images to determine the one or more specific traits.

6. The face recognition system of claim 1, wherein the feature comparator a ranking of potential matches indicating a likelihood of a match between the input image and the plurality of images in the image database.

7. The face recognition system of claim 1, wherein the feature extractor comprises a convolutional neural network (CNN) configured to generate the plurality of feature sets.

8. The face recognition system of claim 1, where the feature comparator is configured to generate a recognition decision for the input image, wherein the recognition decision is one of (i) subject verification decision or (ii) subject recognition decision.

9. A tangible, non-transitory computer readable medium, or media, storing machine readable instructions that, when executed by one or more processors, cause the one or more processors to:
receive an input image;
analyze the input image to determine at least one specific trait;
receive a plurality of data sets based on the determined specific trait;
generate a plurality of feature sets corresponding to the plurality of data sets, wherein respective ones of the feature sets include corresponding features extracted from respective ones of the data sets;
receive a plurality of images from an image database;
compare the input image against the plurality of images from the image database by using the plurality of feature sets; and
select potential matches between the input image and the plurality of images in the image database.

10. The tangible, non-transitory computer readable medium, or media, storing machine readable instructions that, when executed by one or more processors, according to claim 10, cause the one or more processors to:
output a ranking of potential matches indicating a likelihood of a match between the input image and the plurality of images in the image database.

11. The non-transitory computer-readable medium or media of claim 9, wherein the machine readable instructions, when executed by the one or more processors, cause the one or more processors to:
generate a recognition decision for the input image, wherein the recognition decision is one of (i) subject verification decision or (ii) subject recognition decision.

12. The non-transitory computer-readable medium or media of claim 9, wherein respective ones of the data sets include pairs of images with each pair including one image that includes the specific trait and another image that does not include the specific trait.

13. The non-transitory computer-readable medium or media of claim 9, wherein the specific trait is one or more of age range, race, skin color, gender, a scar, or a tattoo.

14. The non-transitory computer-readable medium or media of claim 9, wherein the machine readable instructions, when executed by one or more processors, cause the one or more processors to apply a convolutional neural network (CNN) configured to generate the plurality of feature sets.

15. The non-transitory computer-readable medium or media of claim 9, wherein generating a plurality of feature sets corresponding to the plurality of data sets comprises generating a plurality of vectors that includes a plurality of elements indicating respective features extracted from respective data sets.

16. A method for recognizing faces in a face recognition system, the method comprising:
receiving an input image;
analyzing the input image to determine at least one specific trait;
receiving a plurality of data sets based on the determined specific trait;
generating a plurality of feature sets corresponding to the plurality of data sets, wherein respective ones of the feature sets include corresponding features extracted from respective ones of the data sets;
receiving a plurality of images from an image database;
comparing the input image against the plurality of images from the image database by using the plurality of feature sets; and
outputting a ranking of potential matches indicating a likelihood of a match between the input image and the plurality of images in the image database.

17. The method of claim 16, wherein respective ones of the data sets include pairs of images with each pair including one image that includes the specific trait and another image that does not include the specific trait.

18. The method of claim 16, wherein the specific trait is one or more of age range, race, skin color, gender, a scar, or a tattoo.

19. The method of claim 16, further comprising:
generating a recognition decision for the input image, wherein the recognition decision is one of (i) subject verification decision or (ii) subject recognition decision.

20. The method of claim 16, wherein generating a plurality of feature sets comprises a convolutional neural network (CNN) configured to generate the plurality of feature sets.
